(19) United States
(12) Patent Application Publication
(10) Pub. No.: US 2008/0194718 A1
(43) Pub. Date: Aug. 14, 2008

(54) Method For Producing Viscoelastic Polyurethane-Soft Foam Materials

(75) Inventors: Marita Schuster, Stemwede-Haldem (DE); Andrea Eisenhardt, Vechta (DE); Anja Arlt, Preussisch-Oldendorf / Hed (DE); Volker Varenkamp, Stemshorn (DE); Verena Drogla, Lemforde (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Basf Aktiengesellschaft, Ludwigshafen (DE)

(21) Appl. No.: 11/915,163

(22) PCT Filed: May 17, 2006
(86) PCT No.: PCT/EP2006/062383

§ 371 Date: Nov. 21, 2007

(30) Foreign Application Priority Data
May 23, 2005 (DE) 10 2005 024 144.1

(51) Int. Cl. C08G 18/18

(52) U.S. Cl. 521/177

(57) ABSTRACT

The invention relates to a process for producing viscoelastic polyurethane foams by reacting
a) polyisocyanates with
b) compounds having at least two hydrogen atoms which are reactive toward isocyanate groups in the presence of
c) catalysts,
d) blowing agents, wherein
   ai) diphenylmethane diisocyanate or aii) mixtures of diphenylmethane diisocyanate and polymethylenepolyphenylene polyisocyanates and/or aiii) prepolymers which comprise isocyanate groups and can be prepared by reacting aiv) polyether alcohols with diphenylmethane diisocyanate or mixtures of diphenylmethane diisocyanate and polymethylenepolyphenylene polyisocyanates are used as a) polyisocyanates and mixtures of at least one catalyst ci) and at least one catalyst cii) are used as catalysts.

The invention relates to a process for producing viscoelastic flexible polyurethane foams having reduced emission of organic substances.

Flexible polyurethane foams are used in many industrial fields, in particular for upholstery or acoustic insulation. They are usually produced by reacting polyisocyanates with compounds having at least two hydrogen atoms which are reactive toward isocyanate groups in the presence of blowing agents and, if appropriate, catalysts and customary auxiliaries and/or additives. Viscoelastic flexible polyurethane foams are used, in particular, in the furniture industry, in particular for producing mattresses, and also in the motor vehicle industry, in particular for backfoaming carpets and for sound absorption.

Most polyurethane foams emit volatile organic compounds. These can be, for example, catalysts, degradation products or unreacted volatile starting materials. These emissions are regarded as a quality defect for many uses of the flexible polyurethane foams, for example when used in motor vehicle interiors or when employed in furniture or mattresses.

The market is therefore increasingly demanding low-emission foams. The automobile industry in particular requires a significant reduction of volatile organic compounds (VOC) and condensable compounds (fogging or FOG) in foams.

There have been many attempts in the past to reduce the emission tendency of flexible polyurethane foams.

Since volatile amine catalysts are a significant source of emissions, use has been made of incorporatable catalysts, i.e. catalysts which in addition to the tertiary amino group have further groups which are reactive toward isocyanate groups and via which the catalysts can be built into the polymer framework. Such catalysts are described, for example, in EP-A-451 826 and EP-A-677 540. A disadvantage of the use of incorporatable catalysts is, in particular, that the catalysts which have been built into the polymer framework catalyze the redissociation of urethane groups. As a result, they adversely affect the mechanical properties of the polyurethanes over time and the redissociation can form volatile compounds which in turn can be emitted from the foam.

RD 431026 describes flexible polyurethane foams having reduced emission which have been produced using MDI as isocyanate. Incorporatable amine catalysts are used as catalysts.

A disadvantage of many incorporatable catalysts is the early incorporation into the polymer chain. As a result, the catalysts are no longer freely mobile in the reaction mixture, which can lead to inhomogeneities in the polymer framework.

Since these reactive catalysts also catalyze the reverse reaction, foams based on incorporatable catalysts generally have very much poorer aging properties than foams which have been produced using conventional volatile amine catalysts. In this context, an important requirement which foams have to meet is stability after hot-humid storage. Here, the foam samples are subjected to hot-humid storage and a compressive deformation measurement is subsequently carried out on the specimens. Foams based on incorporatable amine catalysts usually achieve the required emission values after hot-humid storage; however, the reverse reaction caused by the incorporated catalysts leads to faults in the polymer matrix. These usually lead to reduced-emission foams exceeding the specified values for the aging properties. This problem becomes greater with decreasing elasticity of the foam, since in the case of undercrosslinked, viscoelastic foams, the unsatisfactory aging stability cannot be countered by means of a high degree of crosslinking.

In the case of known foams, a reduction in the emission achieved by use of incorporatable catalysts is thus bought at the expense of a deterioration in the aging properties of the foams. However, this is not acceptable for many applications.

It was an object of the present invention to provide viscoelastic, flexible polyurethane foams which have low emission and good mechanical properties, in particular good aging properties.

For the purposes of the present invention, viscoelastic flexible polyurethane foams are foams which have a rebound resilience of <40% and a damping value (loss factor) of at least 0.3.

The object of the invention has been able to be achieved by the use of diphenylmethane diisocyanate (MDI) and/or prepolymers based on MDI as polyisocyanate and the use of a specific catalyst combination.

The invention accordingly provides a process for producing viscoelastic polyurethane foams by reacting
a) at least one polyisocyanate with
b) at least one compound having at least two hydrogen atoms which are reactive toward isocyanate groups in the presence of
c) catalysts and
d) blowing agents, wherein
   ai) diphenylmethane diisocyanate or aii) mixtures of diphenylmethane diisocyanate and polymethylenepolyphenylene polyisocyanates and/or aiii) prepolymers which comprise isocyanate groups and can be prepared by reacting aiv) polyether alcohols with diphenylmethane diisocyanate or mixtures of diphenylmethane diisocyanate and polymethylenepolyphenylene polyisocyanates are used as a) polyisocyanates, and a mixture of at least one catalyst ci) and at least one catalyst cii), with ci) being selected from the group consisting of compounds of the general formulae (I) to (VII),

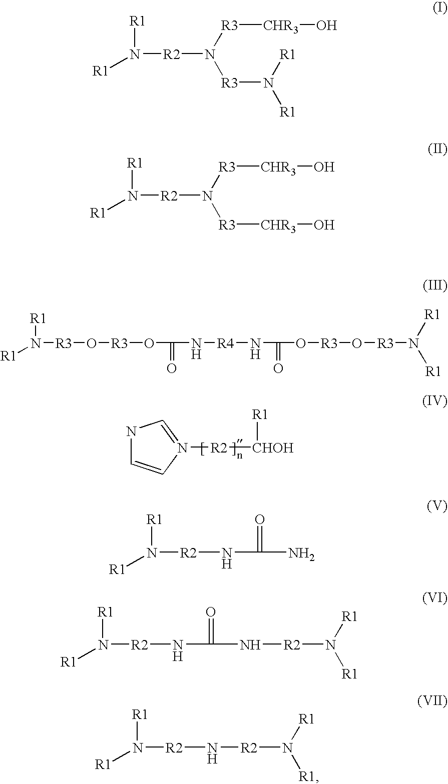

and cii) being selected from the group consisting of compounds of the general formulae (VIII) to (XV),

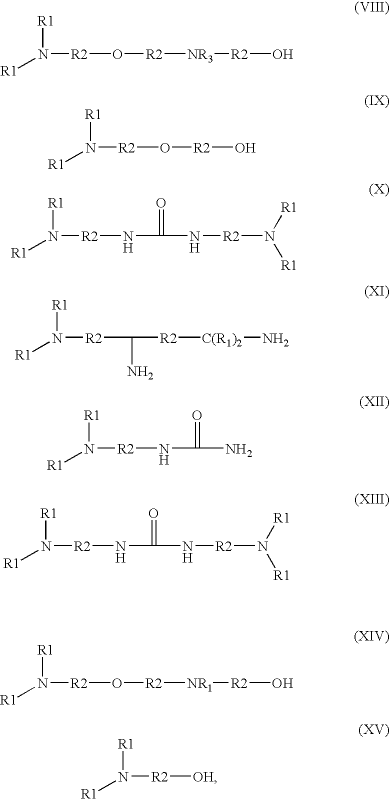

where R1 is a linear, branched or cyclic alkyl radical which has from 1 to 5 carbon atoms and may optionally be substituted by a heteroatom,
R2 is an aliphatic, cycloaliphatic or aromatic radical having from 1 to 10 carbon atoms, and
R3 is a linear, branched or cyclic radical which has from 1 to 5 carbon atoms and may optionally be substituted by a heteroatom,
is used as catalysts c).

The heteroatoms are preferably halogen atoms, in particular chlorine.

As polyisocyanates a), use is made of, as described, ai) diphenylmethane diisocyanate (MDI) or aii) mixtures of diphenylmethane diisocyanate and polymethylenepolyphenylene polyisocyanates (crude MDI) and/or aiii) prepolymers which comprise isocyanate groups and can be prepared by reacting aiv) polyether alcohols with diphenylmethane diisocyanate or mixtures of diphenylmethane diisocyanate and polymethylenepolyphenylene polyisocyanates.

As MDI ai), it is possible to use all isomers of 2-ring MDI. The proportion of 4,4′-MDI in the MDI is preferably at least 80% by weight, particularly preferably at least 90% by weight. The remainder is essentially 2,4′-MDI.

The mixtures of diphenylmethane diisocyanate and polymethylenepolyphenylene poly-isocyanates (crude MDI) aii) usually have an NCO content in the range from 29 to 33% by weight. The content of 2-ring MDI is preferably in the range from 37 to 41% by weight and the content of 3-ring MDI is preferably in the range from 23 to 28% by weight. The remainder is made up of higher-ring homologues. Such products are commercially available and are marketed, for example, by BASF AG as Lupranat® M20.

The prepolymers aiii) preferably have an NCO content of from 23 to 31% by weight, in particular from 25 to 30% by weight. They are usually prepared by reacting aiv) polyether alcohols with diphenylmethane diisocyanate or mixtures of diphenylmethane diisocyanate and polymethylenepolyphenylene polyisocyanates. The composition of the isocyanates corresponds to that of the products described as ai) and aii).

The prepolymers aiii) preferably have a content of 2-ring MDI in the range from 40 to 85% by weight and a content of 3-ring MDI of from 5 to 30% by weight, in each case based on the weight of the prepolymer.

The proportion of 4,4′-MDI in the prepolymer is preferably greater than 35% by weight, particularly preferably in the range from 30 to 70% by weight, in each case based on the prepolymer. The proportion of 2,4′-MDI is, in particular, less than 20% by weight, preferably in the range from 10 to 20% by weight.

As polyether alcohols aiv), preference is given to using 2- to 3-functional polyether alcohols having a hydroxyl number in the range from 25 to 60 mg KOH/g, as are customarily used for producing flexible polyurethane foams.

As compounds having at least two hydrogen atoms which are reactive toward isocyanate groups b), use is made of, in particular, polyester alcohols and/or polyether alcohols bi) in the process of the invention.

The polyether alcohols bi) used usually have a functionality of from 2 to 4, preferably from 2 to 3, and a molecular weight of from 450 to 8000 g/mol, preferably from 3600 to 6500 g/mol. They are usually prepared by catalytic addition of lower alkylene oxides, usually ethylene oxide and/or propylene oxide, onto hydroxyl-functional starter substances. Starter substances used are usually water and/or 2- or 3-functional alcohols such as ethylene glycol, propylene glycol, glycerol or trimethylolpropane (TMP). Alkylene oxides used are, as mentioned, usually ethylene oxide and/or propylene oxide. These can be added on individually, in succession or in admixture with one another. In the case of flexible foam polyether alcohols, an ethylene oxide block is frequently added on at the ends of the chain to increase the proportion of primary hydroxyl groups.

In a preferred embodiment of the invention, the component bi) comprises at least one polyether alcohol which is prepared by addition of alkylene oxides, in particular ethylene oxide and/or propylene oxide, onto 2- or 3-functional alcohols and whose hydroxyl number is in the range from 20 to 450 mg KOH/g, in particular from 20 to 100 mg KOH/g.

The polyether alcohols bi) are usually prepared by catalytic addition of alkylene oxides, in particular ethylene oxide and/or propylene oxide, onto H-functional starter substances. Catalysts used are preferably basic compounds, in particular hydroxides of alkali metals. Recently use is frequently also being made of multimetal cyanide compounds, also referred to as DMC catalysts.

Polymer-modified polyether alcohols can also be used as polyether alcohols bi). These are usually prepared by in-situ polymerization of olefinically unsaturated monomers, in particular acrylonitrile and/or styrene, in the polyether alcohols. Polymer-modified polyether alcohols include polyether alcohols comprising polyurea dispersions.

The polymer-modified polyether alcohols bi) preferably have a hydroxyl number in the range from 10 to 100 mg KOH/g, preferably from 15 to 60 mg KOH/g, and preferably have a solids content of 2-60% by weight, preferably 5-50% by weight.

The polyester alcohols bi) used are usually prepared by condensation of at least bifunctional carboxylic acids with at least bifunctional alcohols. Polyester alcohols bi) used in the process of the invention are, in particular, ones having an average functionality of from 2.0 to 3.5, preferably from 2.0 to 2.8, and an average molecular weight of from 800 to 4000 g/mol, in particular from 1500 to 2800 g/mol.

The compounds having at least 2 groups which are reactive toward isocyanate include chain extenders and crosslinkers. These are preferably H-functional compounds having molecular weights of from 62 to 400 g/mol, in particular 2- to 3-functional alcohols, amines or amino alcohols. Their amount is, in particular, from 0 to 25 parts by weight, preferably from 2 to 12 parts by weight, based on 100 parts by weight of polyether alcohol and/or polyester alcohols.

In a preferred embodiment of the process of the invention, the component b) comprises at least bii) an addition product of alkylene oxide onto a compound having at least one amino group in the molecule, in particular dimethylaminopropylamine. These addition products of alkylene oxide onto a compound having at least one amino group in the molecule, in particular dimethylaminopropylamine, bii) preferably have a molar mass in the range from 160 to 500 g/mol.

They are used in an amount of, in particular, from 0.01 to 10% by weight, based on the weight of the component b).

In a preferred embodiment of the process of the invention, the compounds having at least two hydrogen atoms which are reactive toward isocyanate groups, in particular the polyether alcohols, comprise amine-free antioxidants, i.e. antioxidants which comprise no amino groups. The addition of antioxidants is customary and necessary to suppress thermooxidative degradation of the polyols. Many antioxidants can likewise migrate out of the polymer and thus result in an increase in the emission.

The amine-free stabilizers against thermooxidative degradation comprised in the compounds having at least two hydrogen atoms which are reactive toward isocyanate groups are preferably selected from the group consisting of
i) sterically hindered phenols,
ii) lactones, in particular benzofuran-2-one derivatives,
iii) further amine-free antioxidants which do not release phenol, for example sterically hindered phosphites,
   and also any mixtures of these compounds with one another.

Examples of sterically hindered phenols i) are octadecyl 3-(3,5-di-t-butyl-4-hydroxyphenyl)propionate, 3,5-bis(1,1-dimethylethyl-4-hydroxy-C7-C9-alkyl)-branched esters, ethylene(bisoxyethylene)bis(3-(5-t-butylhydroxy-4-tolyl)propionate.

Examples of lactones ii), in particular benzofuran-2-one derivatives, are described in EP 1291384 and DE 19618786.

Examples of amine-free antioxidants which do not release phenol iii) are described, for example, in the patent EP 905180, for example tris(2,4-di-t-butylphenyl)phosphite.

In a preferred embodiment of the invention, the antioxidants comprise 20-90% by weight, preferably from 50 to 90% by weight, of sterically hindered phenol derivatives and 10-80% by weight, preferably from 10 to 40% by weight, of benzofuran-2-one derivatives and from 0 to 30% by weight, preferably from 0 to 20% by weight, of other amine-free antioxidant compounds which do not release phenol.

These compounds are usually added to the compounds having at least two hydrogen atoms which are reactive toward isocyanate groups b) immediately after preparation of the latter. If necessary, further antioxidants can be added immediately before reaction with the isocyanates. The amount of antioxidants in the compounds having at least two hydrogen atoms which are reactive toward isocyanate groups is usually in the range from 100 to 8000 ppm, preferably from 500 to 5000 ppm.

In a preferred embodiment of the process of the invention, the polyether alcohols aiv) and the polyether alcohols bi) have a block of the same alkylene oxide, in particular ethylene oxide, at the end of the chain.

In a further preferred embodiment of the process of the invention, the hydroxyl number of the polyether alcohol aiv) is from 5 to 12 mg KOH/g above or below the hydroxyl number of the polyether alcohol bi). In this embodiment, the hydroxyl number of the polyether alcohol bi) is preferably in the range from 20 to 100 mg KOH/g.

The catalysts c) are preferably used in an amount of from 0.02 to 5% by weight. The ratio of the catalysts ci) and cii) to one another depends on the desired properties of the foams. As described, it is necessary for at least one catalyst ci) and at least one catalyst cii) to be present. In principle, it is also possible to use a plurality of catalysts ci) and cii).

Furthermore, blowing agents and, if appropriate, auxiliaries and/or additives are also used in the process of the invention.

As blowing agent in the process of the invention, use is usually made of water which reacts with isocyanate groups to form carbon dioxide. The amounts of water which are advantageously used are, depending on the desired density of the foams, from 0.1 to 8 parts by weight, preferably from 1.5 to 5 parts by weight, based on 100 parts by weight of component b).

It is also possible, if appropriate, to use physically acting blowing agents in admixture with water. These are liquids which are inert toward the constituents of the formulation and have boiling points below 100° C., preferably below 50° C., in particular in the range from −50° C. to 30° C., at atmospheric pressure, so that they vaporize under the action of the exothermic polyaddition reaction. Examples of such liquids which can preferably be used are hydrocarbons such as pentane, n-butane and isobutane and propane, ethers such as dimethyl ether and diethyl ether, ketones such as acetone and methyl ethyl ketone, ethyl acetate and preferably halogenated hydrocarbons such as methylene chloride, trichlorofluoromethane, dichlorodifluoromethane, dichloromonofluoromethane, dichlorotetrafluoroethane and 1,1,2-trichloro-1,2,2-trifluoroethane. Mixtures of these low-boiling liquids with one another and/or with other substituted or unsubstituted hydrocarbons can also be used.

Carbon dioxide can also be used as blowing agent and this is preferably dissolved as gas in the starting components.

Preference is given to using water and/or carbon dioxide as blowing agent.

The amount of physically acting blowing agents required in addition to water can be determined in a simple manner as a function of the desired foam density and is from about 0 to 50 parts by weight, preferably from 0 to 20 parts by weight, per 100 parts by weight of polyhydroxyl compound.

Auxiliaries and/or additives can also be incorporated into the reaction mixture. Mention may be made, for example, of external and internal mold release agents, foam stabilizers, hydrolysis inhibitors, pore regulators, fungistatic and bacteriostatic substances, dyes, pigments, fillers, surface-active substances and flame retardants.

In the industrial production of polyurethane foams, it is customary to combine the compounds having at least two active hydrogen atoms and the further starting materials and also auxiliaries and/or additives to form a polyol component prior to the reaction.

Further information about the starting materials used may be found, for example, in Kunststoffhandbuch, Volume 7, Polyurethane, edited by Günter Oertel, Carl-Hanser-Verlag, Munich, 3rd edition 1993.

To produce the polyurethanes according to the invention, the organic polyisocyanates are reacted with the compounds having at least two active hydrogen atoms in the presence of the above-mentioned blowing agents, catalysts and auxiliaries and/or additives, usually in the form of a polyol component.

To produce the polyurethanes according to the invention, isocyanate component and polyol component are reacted in such amounts that the index is preferably in the range from 50 to 200, preferably from 70 to 150 and in particular from 80 to 120.

The polyurethane foams are preferably produced by the one-shot process, for example by means of the high-pressure or low-pressure technique. The foams can be produced in open or closed metallic molds or by continuous application of the reaction mixture to conveyor belts to produce slabstock foams.

It is particularly advantageous to employ the two-component process in which, as mentioned above, a polyol component and an isocyanate component are prepared and foamed. The components are preferably mixed at a temperature in the range from 15 to 120° C., more preferably from 20 to 80° C., and introduced into the mold or applied to the conveyor belt. The temperature in the mold is usually in the range from 15 to 120° C., preferably from 30 to 80° C.

The flexible polyurethane foams produced by the process of the invention have, as described, a very low emission (VOC and FOG) combined with the mechanical properties and aging properties required by the market.

They are preferably used in motor vehicle interiors and for producing furniture and mattresses.

The invention is illustrated by the following examples.

### EXAMPLES 1 TO 4 AND COMPARATIVE EXAMPLES 1 AND 2

The polyols, catalysts and additives listed in Tables 1 and 2 were mixed to form a polyol component and then mixed with the prepolymers comprising isocyanate groups at the isocyanate index indicated by means of a solid wheel stirrer in a manual experiment, the mixture was introduced into a mold and allowed to foam there.

The properties reported in Tables 1 and 2 were determined on the foams obtained.

TABLE 1

| Formulation | | Comparative example | Example | Example | Example |
|---|---|---|---|---|---|
| Polyol 1 | pbm | 56.30 | 54.85 | 58.45 | 58.45 |
| Polyol 2 | pbm | 31.00 | 26.00 | 26.00 | 26.00 |
| Polyol 3 | pbm | 7.50 | 7.50 | 7.50 | 7.50 |
| Polyol 4 | | | 5.50 | 2.00 | 2.00 |
| Water | pbm | 2.30 | 3.10 | 3.10 | 3.10 |
| Stabilizer 1 | pbm | 0.70 | 0.90 | 0.90 | 0.90 |
| Catalyst 1 | pbm | 0.10 | | | |
| Catalyst 2 | pbm | 0.65 | | | |
| Catalyst 3 | pbm | 0.20 | | | |
| Catalyst 4 | pbm | 0.10 | | | |
| Emulsifier | | 1.00 | 1.00 | 1.00 | 1.00 |
| Color paste | | 0.15 | 0.15 | 0.15 | 0.15 |
| Catalyst 5 | | | 0.41 | 0.30 | 0.30 |
| Catalyst 6 | | | | 0.30 | 0.30 |
| Catalyst 7 | | | 0.2 | | |
| Catalyst 8 | | | 0.1 | | |
| Catalyst 11 | | | 0.30 | 0.30 | 0.30 |
| Iso 1 | | X | X | X | |
| Iso 2 | | | | | X |
| | Index | 80 | 80 | 80 | 78 |

Processing behavior

| | | | | | |
|---|---|---|---|---|---|
| Foam density, core | kg/m³ | 76 | 60 | 59 | 59 |
| Elongation at break | % | 145 | 150 | 155 | 146 |
| Tensile strength | kPa | 125 | 135 | 135 | 134 |
| Compression set | % | 3.2 | 11 | 10.5 | 8.1 |
| After aging | % | 7.5 | 23.8 | 26.3 | 12.3 |
| 5 h, 120° C. 2 cycles | | | | | |
| Compressive strength | kPa | 5.8 | 4.7 | 4.4 | 5.4 |
| 40% | | | | | |
| Loss factor | | 0.41 | 0.39 | 0.38 | 0.37 |
| Storage modulus | N/cm² | 16.5 | 12.8 | 11.6 | 21.1 |

Gaseous and condensable emissions

| | | | | |
|---|---|---|---|---|
| VOC in accordance | | | | |
| with DC-PB VWL 709 | | | | |
| Total | ppm | 524 | 81 | 98 |
| 1,4-Diaza- | ppm | 83 | 36 | 27 |
| bicyclo[2.2.2]octane | | | | |
| Diphenylamine | ppm | 5 | 0 | 0 |
| derivatives | | | | |
| Bis(dimethylaminoethyl) | | 71 | 0 | 0 |
| ether | | | | |
| Fogging in accordance | | | | |
| with DC-PB VWL 709 | | | | |
| Total | ppm | 185 | 94 | 27 |
| Diphenylamine | ppm | 11 | 0 | 0 |
| derivatives | | | | |

TABLE 2

| Formulation | | Comparative example | Example |
|---|---|---|---|
| Polyol 1 | pbm | 56.30 | 62.2 |
| Polyol 2 | pbm | 31.00 | 24.5 |
| Polyol 3 | pbm | 7.50 | 7.50 |
| Polyol 4 | | | |
| Water | pbm | 2.30 | 2.95 |
| Dabco ® DC 2525 | pbm | 0.70 | 1.0 |
| Catalyst 1 | pbm | 0.10 | |
| Catalyst 2 | pbm | 0.65 | |
| Catalyst 3 | pbm | 0.20 | |
| Catalyst 4 | pbm | 0.10 | |
| Emulsifier | | 1.00 | 1.00 |
| Color paste | | 0.15 | 0.15 |
| Catalyst 5 | | | 0.05 |
| Catalyst 7 | | | 0.65 |
| Catalyst 8 | | | 0.1 |
| Catalyst 9 | | | 0.5 |
| Catalyst 10 | | | 0.4 |
| Iso 1 | | X | X |
| Iso 2 | | | |
| | Index | 80 | 80 |

Processing behavior

| | | | |
|---|---|---|---|
| Foam density, core | kg/m³ | 76 | 75 |
| Elongation at break | % | 145 | 148 |
| Tensile strength | kPa | 125 | 177 |
| Compression set | % | 3.2 | 7.3 |
| After aging | % | 7.5 | 22.4 |
| 5 h, 120° C. 2 cycles | | | |
| Compressive strength | kPa | 5.8 | 5.1 |
| 40% | | | |
| Loss factor | | 0.41 | 0.41 |
| Storage modulus | N/cm² | 16.5 | 20 |

Gaseous and condensable emissions

| | | | |
|---|---|---|---|
| VOC in accordance | | | |
| with DC-PB VWL 709 | | | |
| Total | ppm | 524 | 65 |
| 1,4-Diaza- | ppm | 83 | 0 |
| bicyclo[2.2.2]octane | | | |
| Diphenylamine | ppm | 5 | 0 |
| derivatives | | | |
| Bis(dimethylaminoethyl) | | 71 | 0 |
| ether | | | |
| Fogging in accordance | | | |
| with DC-PB VWL 709 | | | |
| Total | ppm | 185 | 88 |
| Diphenylamine | ppm | 11 | |
| derivatives | | | |

### Explanation

pbm—parts by mass
Polyol 1—polyether alcohol derived from glycerol, a PO block and an end block of ethylene oxide, hydroxyl number: 25-28 mg KOH/g
Polyol 2—polyether alcohol derived from glycerol, a heteroblock of propylene oxide and ethylene oxide and an end block of ethylene oxide, hydroxyl number: 42 mg KOH/g,
Polyol 3—polyether alcohol derived from propylene glycol and propylene oxide, hydroxyl number: 250 mg KOH/g
Polyol 4—polyether alcohol derived from ethylenediamine, an propylene oxide block and an ethylene oxide end block
Stabilizer 1—Dabco® DC 2525, from Air Products
Catalyst 1—Dabco BL 11®, from Air Products
Catalyst 2—Dabco 8154®, from Air Products
Catalyst 3—Niax A 107®, from Osi,
Catalyst 4—Lupranat N 201®, from BASF
Catalyst 5—bisdimethylaminopropylurea
Catalyst 6—bis(N,N-dimethylaminoethoxyethyl)carbamate,
Catalyst 7—dimethylaminopropylurea,
Catalyst 8—N,N,N-trimethylaminopropyl N-methyl-N-hydroxyethylaminopropyl ether
Catalyst 9—diethylethanolamine
Catalyst 10—bis(N,N-dimethyl-3-aminopropyl)amine
Catalyst 11—dimethylaminopropylamine
Iso 1—reaction product of a mixture of 9.5 parts by weight of 2,4′-MDI, 56.1 parts by weight of 4,4′-MDI and 21.4 parts by weight of polymeric MDI with a trifunctional polyether alcohol based on propylene oxide and ethylene oxide, hydroxyl number: 42 mg KOH/g, NCO content: 28% by weight
Iso 2—reaction product of a mixture of 22 parts by weight of 2,4′-MDI, 47.5 parts by weight of 4,4′-MDI and 20.1 parts by weight of polymeric MDI with a trifunctional polyether alcohol based on propylene oxide and ethylene oxide, hydroxyl number: 35 mg KOH/g, NCO content: 29% by weight.

The properties were determined by the following measurement methods.

| | |
|---|---|
| Foam density in kg/m³ | DIN EN ISO 845 |
| VOC in ppm | PB VWL 709 |
| FOG in ppm | PB VWL 709 |
| Elongation at break in % | DIN EN ISO 1798 |
| Tensile strength in kPa | DIN EN ISO 1798 |
| Compression set in % | DIN EN ISO 1856 |
| Compression set after | DIN EN ISO 1856 |
| autoclave aging in % | |
| Compressive strength in kPa | DIN EN ISO 3386 |
| Loss factor | DBL 5452 |
| Storage modulus in N/cm² | DBL 5452 |

1. A process for producing viscoelastic polyurethane foams by reacting
a) at least one polyisocyanate with
b) at least one compound having at least two hydrogen atoms which are reactive toward isocyanate groups in the presence of
c) catalysts and
d) blowing agents, wherein
ai) diphenylmethane diisocyanate or aii) mixtures of diphenylmethane diisocyanate and polymethylenepolyphenylene polyisocyanates and/or aiii) prepolymers which comprise isocyanate groups and can be prepared by reacting aiv) polyether alcohols with diphenylmethane diisocyanate or mixtures of diphenylmethane diisocyanate and polymethylenepolyphenylene polyisocyanates are used as a) polyisocyanates, and a mixture of at least one catalyst ci) and at least one catalyst cii), with ci) being selected from the group consisting of compounds of the general formulae (I) to (VII), 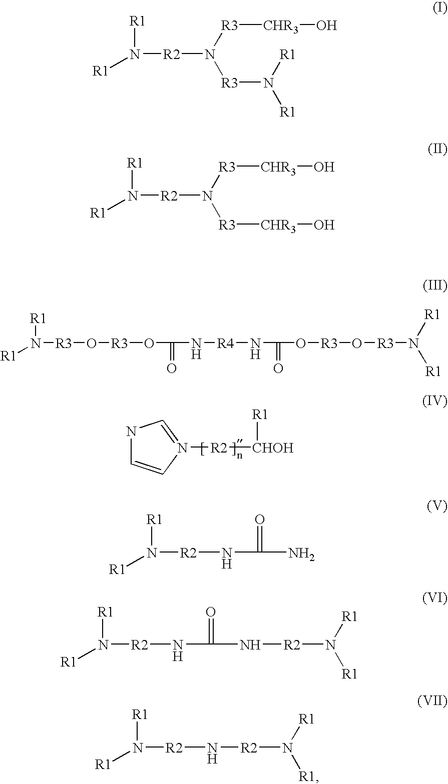
and cii) being selected from the group comprising compounds of the general formulae (VIII) to (XV), 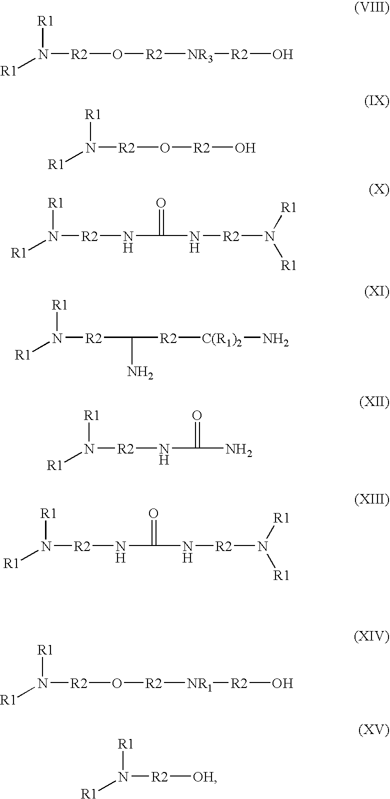
where R1 is a linear, branched or cyclic alkyl radical which has from 1 to 5 carbon atoms and may optionally be substituted by a heteroatom,
R2 is an aliphatic, cycloaliphatic or aromatic radical having from 1 to 10 carbon atoms, and
R3 is a linear, branched or cyclic radical which has from 1 to 5 carbon atoms and may optionally be substituted by a heteroatom,
is used as catalysts c).

2. The process according to claim 1, wherein the prepolymers aiii) comprising isocyanate groups have an NCO content in the range from 23 to 32% by weight.

3. The process according to claim 1, wherein the catalysts c) are used in an amount of 0.02-5% by weight, based on the weight of all starting components for the process.

4. The process according to claim 1, wherein the prepolymers aiii) comprising isocyanate groups have a content of diphenylmethane 4,4′-diisocyanate of 35-70% by weight, based on the weight of the prepolymer.

5. The process according to claim 1, wherein the prepolymers aiii) comprising isocyanate groups have a content of diphenylmethane 2,4′-diisocyanate of from 10-20% by weight, based on the weight of the prepolymer.

6. The process according to claim 1, wherein the prepolymers aiii) comprising isocyanate groups have a content of 2-ring diphenylmethane diisocyanate of from 40 to 85% by weight and a content of 3-ring or higher-ring diphenylmethane diisocyanate of from 5 to 30% by weight, in each case based on the weight of the prepolymer.

7. The process according to claim 1, wherein the component b) comprises at least bii) an addition product of alkylene oxide onto a compound having at least one amino group in the molecule.

8. The process according to claim 1, wherein the component bii) has a hydroxyl number in the range from 160 to 500 mg KOH/g.

9. The process according to claim 1, wherein the component bii) is used in an amount of 0.01-10% by weight, based on the weight of all starting components for the process.

10. The process according to claim 1, wherein the component bii) is at least one addition product of alkylene oxide onto dimethylaminopropylamine.

11. The process according to claim 1, wherein the component bi) comprises at least one polyether alcohol bi) which has been prepared by addition of alkylene oxide onto a bifunctional and/or trifunctional alcohol and has a hydroxyl number in the range from 20 to 450 mg KOH/g.

12. The process according to claim 1, wherein the polyether alcohols aiv) and bi) have an end block of the same alkylene oxide in their polyether chain.

13. The process according to claim 1, wherein the hydroxyl number of the polyether alcohol aiv) is from 5 to 12 mg KOH/g above or below the hydroxyl number of the polyether alcohol bi).
